(19) United States
(12) Patent Application Publication
(10) Pub. No.: US 2003/0115226 A1
(43) Pub. Date: Jun. 19, 2003

(54) Method, apparatus, and program for quick save to remote storage

(75) Inventor: Prabhakar Gopalan, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/015,857

(22) Filed: Dec. 13, 2001

(51) Int. Cl. G06F 12/00

(52) U.S. Cl. 707/205

(57) ABSTRACT

The present invention provides a remote save mechanism that allows a user to transfer a document or file or a portion thereof to a predetermined directory or folder from the interface of an application. The contents of the document or file may be stored in a file format that is consistent with the application or with the original file. The remote save mechanism may be configured to synchronize the contents of the predetermined directory or folder with a remotely located copy either periodically or in response to a request from the user. The remotely located copy may be managed by a server. The remote server may require authentication for the user to access the remotely located copy of files. The user may then access the files from any location without the need for removable media or mobile devices.

### BACKGROUND OF THE INVENTION

1. Technical Field

The present invention relates to data processing and, in particular, to managing files in a data processing system. Still more particularly, the present invention provides a method, apparatus, and program for allowing quick saving of files to remote storage.

2. Description of Related Art

In the course of using a client device, the user may encounter several documents or files that will be required at another location. Typically, the user would need to transfer those files to a removable storage device or mobile device. However, the files may be scattered across several directories, folders, drives, or even servers. Thus, to collect the files onto a removable storage device or mobile device requires using an interface for copying the files from its location to the appropriate destination. Even simply the documents or files while they are open in an application requires navigating a save dialog to locate the destination device.

Furthermore, if only a portion of a document or file is desired, the user must either save the entire file or create another version of the document or file containing only the desired portion. Creating this second file or document may require several tedious steps, such as creating a new document, copying a selected portion, pasting the copied portion, etc. Then, the user must navigate the save dialog to locate the destination device, as stated above.

Still further, to have a portable copy of needed files, the user must physically carry the removable storage device or mobile device. When the user then wishes to accesses those files at another client device, the client device must be able to read the removable storage device or must be configured with an interface for the mobile device. The user also risks losing the removable storage device or mobile device. For these reasons, creating a portable copy if needed files is inconvenient and unreliable.

Therefore, it would be advantageous to provide an improved mechanism for creating a portable copy of files.

### SUMMARY OF THE INVENTION

The present invention provides a remote save mechanism that allows a user to transfer a document or file or a portion thereof to a predetermined directory or folder from the interface of an application. The contents of the document or file may be stored in a file format that is consistent with the application or with the original file. If a portion is selected for transfer to the predetermined directory or folder, the portion may be stored in a file format that is consistent with the selected portion.

The remote save mechanism may be configured to synchronize the contents of the predetermined directory or folder with a remotely located copy either periodically or in response to a request from the user. The remotely located copy may be managed by a server. The remote server may require authentication for the user to access the remotely located copy of files. The user may then access the files from any location without the need for removable media or mobile devices.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIGS. 4A and 4B depict example screens of display of an application window in accordance with a preferred embodiment of the present invention;

FIG. 5 is an example screen of display of a remote access window in accordance with a preferred embodiment of the present invention;

FIG. 6 is an exemplary block diagram of a data processing system with quick remote save in accordance with a preferred embodiment of the present invention;

FIGS. 7A and 7B are flowcharts illustrating the operation of a remote save mechanism in accordance with a preferred embodiment of the present invention; and

FIG. 8 is a flowchart illustrating the operation of a remote server in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

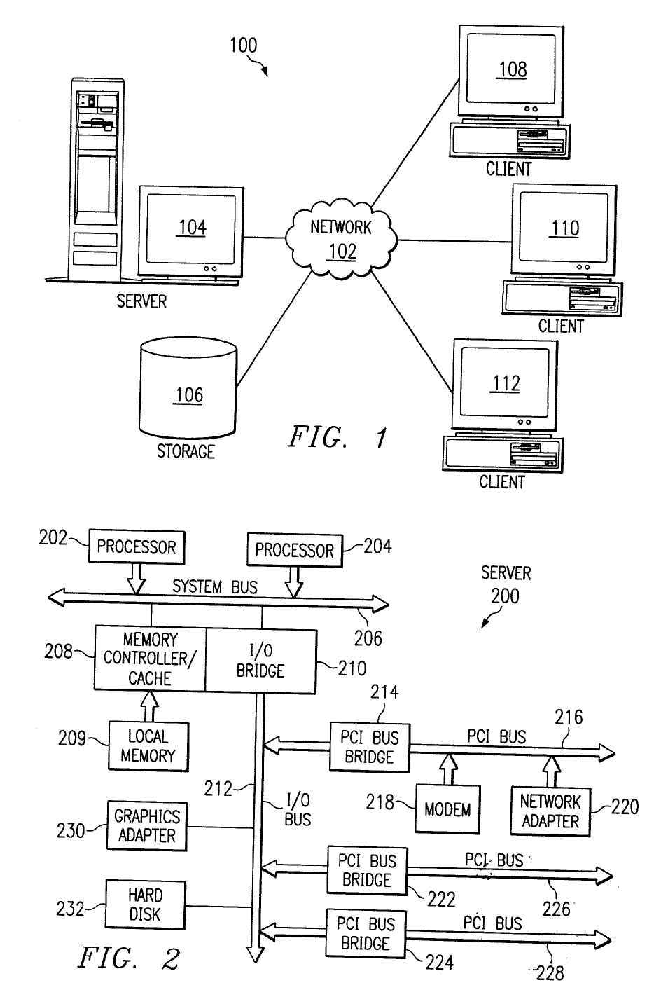

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pseries system, a product of International Business Machines Corporation in Armonk, N.Y., running the Advanced Interactive Executive (AIX) operating system or LINUX operating system.

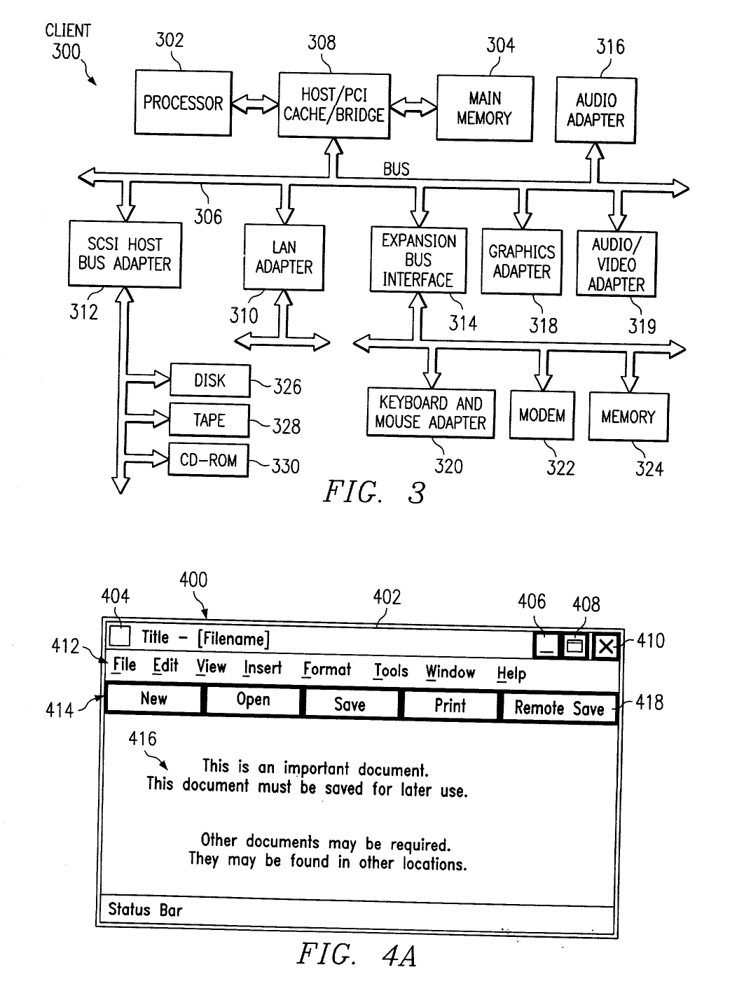

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

In the course of using a client device, the user may encounter several data items, such as documents or files, that will be required at another location. Typically, the user would need to transfer those data items to a removable storage device or mobile device. However, the data items may be scattered across several directories, folders, drives, or even servers. Thus, to collect the data items onto a removable storage device or mobile device requires using an interface for copying the files from its location to the appropriate destination. Even simply the documents or files while they are open in an application requires navigating a save dialog to locate the destination device.

Furthermore, if only a portion of a data item is desired, the user must either save the entire file or create another version of the data item containing only the desired portion. Creating this second file or document may require several tedious steps, such as creating a new document, copying a selected portion, pasting the copied portion, etc. Then, the user must navigate the save dialog to locate the destination device, as stated above.

Still further, to have a portable copy of needed files, the user must physically carry the removable storage device or mobile device. When the user then wishes to accesses those files at another client device, the client device must be able to read the removable storage device or must be configured with an interface for the mobile device. The user also risks losing the removable storage device or mobile device. For these reasons, creating a portable copy if needed files is inconvenient and unreliable.

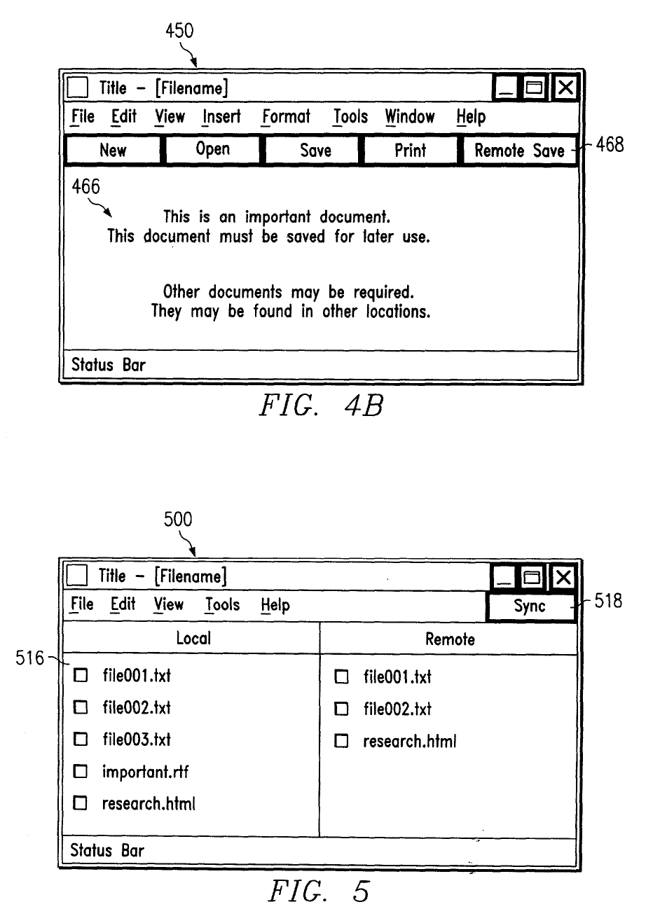

Example screens of display of an application window are shown in FIGS. 4A and 4B in accordance with a preferred embodiment of the present invention. Particularly, with reference to FIG. 4A, the screen comprises window 400, including a title bar 402, which may display the name of the application program. Title bar 402 also includes a control box 404, which produces a drop-down menu (not shown) when selected with the mouse, and “minimize” 406, “maximize” or “restore” 408, and “close” 410 buttons. The “minimize” and “maximize” or “restore” buttons 406 and 408 determine the manner in which the program window is displayed. In this example, the “close” button 410 produces an “exit” command when selected. The drop-down menu produced by selecting control box 404 includes commands corresponding to “minimize,” “maximize” or “restore,” and “close” buttons, as well as “move” and “resize” commands.

Application window 400 also includes a menu bar 412. Menus to be selected from menu bar 412 may include “File,” “Edit,” “View,” “Insert,” “Format,” “Tools,” “Window,” and “Help.” However, menu bar 412 may include fewer or more menus, as understood by a person of ordinary skill in the art. The application window display area includes a display area 416 in which a document or file is displayed.

Window 400 also includes tool bar 414 for displaying buttons that may be selected to perform frequently used functions. In accordance with a preferred embodiment of the present invention, “Remote Save” button 418 is added to the tool bar by installing a plug-in for the graphical user interface of the application. The application vendor may release application program interfaces (API) to enable plug-ins. When the user selects button 418, the document or file displayed in display area 416 is saved or copied to a predetermined remote save directory or folder. The button may also be associated with a keyboard shortcut or voice command to allow the user to quickly and easily save the document or file, or portion thereof, with a single action.

Alternatively, the user may select a portion of the document or file. FIG. 4B shows an example screen of display of an application in which a portion of a displayed document is selected. Application window 450 displays a document. Portion 466 is selected by a user. If “Remote Save” button 468 is selected while the portion is selected, the remote save mechanism may create a new version of the document containing the selected portion.

The portion may be stored in a file format that is consistent with the selected portion. For example, if a portion of text is selected, the portion may be stored as a text file or in a format that is consistent with the application or original document. If an image is selected within a document, the selected content may be stored in an image format, such as bitmap or graphics interchange format (GIF) for example.

In the example shown in FIG. 4B, the document is textual. The selected portion may be stored in a format that is consistent with the original document, such as rich text format (RTF). Alternatively, the portion may be stored as a text file. The manner in which portions are saved may be defined by the user.

The remote save mechanism may be configured to synchronize the contents of the remote save directory or folder with a remotely located copy either periodically or in response to a request from the user. The remotely located copy may be managed by a server. The remote server may require authentication for the user to access the remotely located copy of files. The user may then access the files from any location without the need for removable media or mobile devices.

With reference to FIG. 5, an example screen of display of a remote access window is shown in accordance with a preferred embodiment of the present invention. Remote access window 500 includes display area 516 in which local and remote copies of files are stored. The remote files may be stored on a server, such as a network file server or Web server. The server may be, for example, server 104 in FIG. 1. The server may require authentication information from the user before granting access to the remote files. Thus, the server may save account information for users. The account information may include the authentication information, such as a user name and password, and the location on the server for that user's remote files.

The local files are the files stored in the remote save directory. These files may be updated versions of files already stored remotely or may be new files to be saved on the server. The user may initiate synchronization of the files by selecting “Sync” button 518. The synchronization between remote and local copies of the files may then be performed using known transfer protocols, such as File Transfer Protocol (FTP), or a protocol specifically designed for the remote save mechanism. In an alternative embodiment of the present invention, synchronization may be performed automatically on a periodic basis or when the operating system shuts down.

The interface shown in FIG. 5 may also be used to manage the files in the remote storage. For example, the user may delete files that are no longer needed, rename files, move or copy files to other locations, etc. The user may also manage files in the remote save directory before synchronizing.

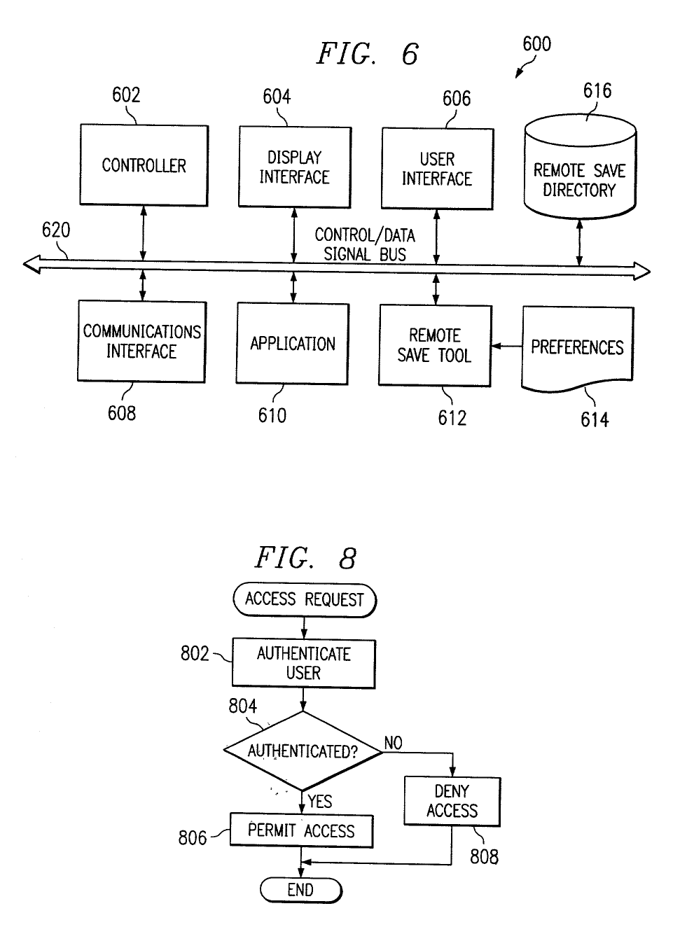

FIG. 6 is an exemplary block diagram of a data processing system with quick remote save in accordance with a preferred embodiment of the present invention. Data processing system 600 includes a controller 602, a display interface 604, a user interface 606, a communications interface 608, an application 610, and a remote save tool 612. The elements 602-612 may be implemented as hardware, software, or a combination of hardware and software. In a preferred embodiment, the elements 602-612 are implemented as software instructions executed by one or more processors.

The elements 602-612 are coupled to one another via the control/data signal bus 620. Although a bus architecture is shown in FIG. 6, the present invention is not limited to such. Rather, any architecture that facilitates the communication of control/data signals between elements 602-612 may be used without departing from the spirit and scope of the present invention. The controller 602 controls the overall operation of the document viewer and orchestrates the operation of the other elements 604-612.

With the operation of the present invention, application 610 instructs controller 602 to display a document or file via display interface 604. The user interacts with the application via user interface 606. Remote save tool 612, when enabled, allows the user to quickly save a document or file of interest, or a portion thereof, to remote save directory 616. This may be achieved by adding a button to application 610 and user interface 606. The user may then perform the save by selecting the button, thus allowing the user to save the desired content with a single click of a mouse or other action.

Application 610 may retrieve documents from a remote location. For example, the document viewer may be a Web browser. Thus, data processing system 600 may receive documents to display from communications interface 608.

The remote save tool may be a plug-in for application 610. In accordance with a preferred embodiment of the present invention, remote save tool 612 may also include an interface for allowing a user to synchronize contents of remote save directory 616 with a copy on a remote server through communications interface 608. The remote server may be a network file server or Web server. The server may require authentication information from the user before granting access to the remote files.

The location of the server, authentication information, and the location of the remote save directory may be stored in preferences 614. The preference may also include other information, such as whether files are to be synchronized automatically, the frequency with which files are to be synchronized, etc.

In an alternative embodiment, data processing system 600 may support a multi-user environment. In this case, preferences for multiple users may be stored in preferences 614. Thus, a first user may sign into the system, store files in a first directory, and automatically synchronize those files to a first remote server with a first username and password. A second user may sign into the system, store files in a second directory, and synchronize those files to a second remote server with a second username and password in response to an action by the second user.

In another embodiment, a user may wish to synchronize the remote directory to another storage device that is either located either locally or remotely. For example, a user may wish to synchronize the contents of the remote save directory with a removable storage device, such as a floppy disk, or a mobile device, such as a personal digital assistant (PDA). Thus, preferences 614 may include a profile (set of user preferences) that designates a removable storage device or mobile device as the remote storage.

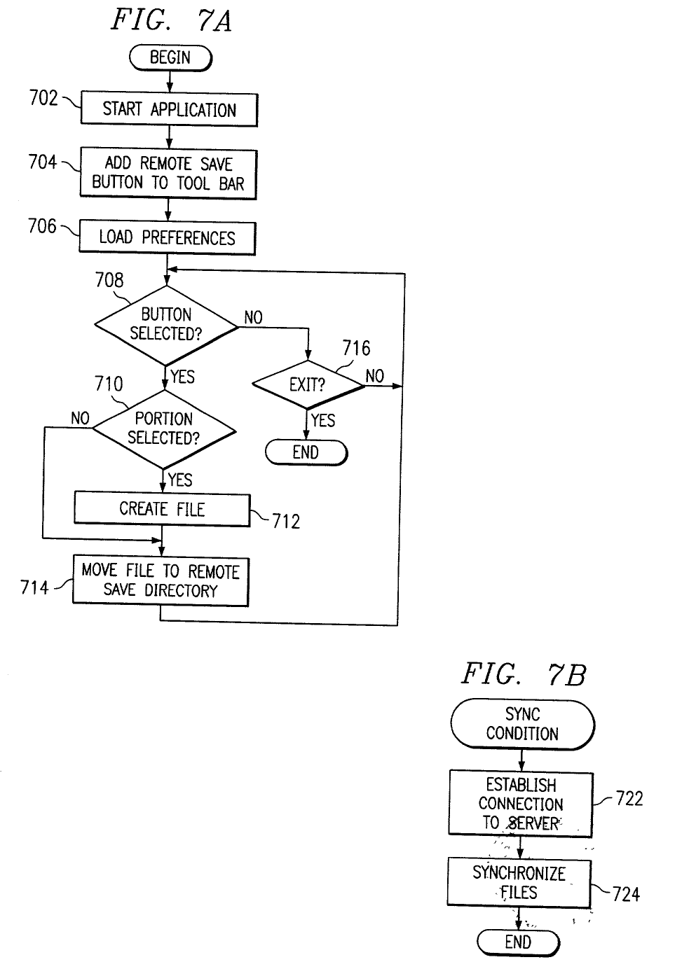

With reference now to FIGS. 7A and 7B, flowcharts illustrating the operation of a remote save mechanism are shown in accordance with a preferred embodiment of the present invention. Particularly, with respect to FIG. 7A, the operation of a remote save plug-in for an application is shown. The process begins and starts an application (step 702). Then, the process adds a remote save button to the tool bar or button bar of the application (step 704) and loads user preferences (step 706).

Next, a determination is made as to whether the button is selected (step 708). If the button is selected, a determination is made as to whether a portion of a file or document is selected in the application (step 710). If a portion of the document or file is selected, the process creates a file for the portion (step 712), moves the file to the remote save directory or folder (step 714), and returns to step 708 to determine if the button is selected. If, however, a portion of a document or file is not selected in step 710, the process moves the file that is open in the application to the remote save directory (step 714) and returns to step 708 to determine whether the button is selected.

Returning to step 708, if the button is not selected, a determination is made as to whether an exit condition exists (step 716). If an exit condition exists, the process ends. If an exit condition does not exist in step 716, the process returns to step 708 to determine whether the button is selected.

With reference to FIG. 7B, a flowchart of the operation of synchronization in the remote save mechanism is shown. The process begins when a synchronization condition exists. A synchronization condition may be, for example, the selection of a synchronization button on a user interface or the expiration of a timer. For example, the remote save mechanism may be configured to synchronize the remote save directory with a copy on a remote server every ten minutes.

When a synchronization condition is received, the process establishes a connection to the server (step 722). Thereafter, the process synchronizes the files (step 724) and ends. Synchronization of the files may simply comprise moving or copying the files from the remote save directory to the remote server. However, synchronization may also consists of copying files from the server to the remote save directory on the local machine if the remote copy is more recent.

Turning to FIG. 8, a flowchart illustrating the operation of a remote server is shown in accordance with a preferred embodiment of the present invention. The process begins when an access request is received. Then, the process authenticates a user (step 802). A determination is made as to whether the user is authenticated (step 804). If the user is authenticated, the process permits access to the files on the remote server (step 806). However, if the user is not authenticated in step 804, the process denies access (step 808) and ends.

Thus, the present invention solves the disadvantages of the prior art by providing a remote save mechanism that allows a user to designate a document or file, or a portion thereof, to be saved in a remote location. If only a portion of a file is to be saved, the remote save mechanism performs the actions necessary to save only the portion. The present invention allows the user to store a file or document at a remote location with a single action, such as a single mouse click or key sequence. Furthermore, the remote copy of the files or documents may be accessed at any location. For example, if the files are stored on a Web server or FTP server, the user may then access the files from any computer with an Internet connection.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for remotely storing data, comprising:
opening a first data item in an application on a first client device;
in response to an action from a user, storing at least a portion of the first data item in a predetermined storage location on the first client device; and
in response to a synchronization condition, automatically synchronizing contents of the predetermined location with a remote storage location.

2. The method of claim 1, further comprising:
adding a remote save button to an interface of the application.

3. The method of claim 2, wherein the action comprises selection of the remote save button.

4. The method of claim 1, wherein the predetermined storage location comprises a predetermined directory or folder.

5. The method of claim 1, further comprising:
loading a set of preferences for a user.

6. The method of claim 5, wherein the step of storing comprises storing the at least a portion of the first data item based on the set of preferences.

7. The method of claim 5, wherein the remote storage location is identified in the set of preferences.

8. The method of claim 5, wherein the set of preferences is one of a plurality of sets of preferences in a multi-user environment.

9. The method of claim 1, further comprising:
identifying a selected portion of the first data item,
wherein the step of storing comprises creating a second data item comprising the selected portion, and storing the second data item in the predetermined storage location.

10. The method of claim 1, wherein the synchronization condition comprises selection of a synchronization button.

11. The method of claim 1, wherein the synchronization condition comprises expiration of predetermined time period.

12. The method of claim 1, wherein the remote storage location comprises a server device.

13. The method of 12, wherein the server device comprises one of a network file server and a Web server.

14. The method of claim 12, further comprising:
requesting, at a second client device, access to the server device; and
in response to receiving permission from the server device, accessing, at the second client device, data items stored in the remote storage location.

15. The method of claim 14, wherein the step of requesting access to the server device comprises sending authentication information from the second client device to the server device.

16. The method of claim 15, wherein the authentication information comprises a username and a password.

17. An apparatus for remotely storing data, comprising:
means for opening a first data item in an application on a first client device;
means for storing at least a portion of the first data item in a predetermined storage location on the first client device in response to an action from a user; and
means for automatically synchronizing contents of the predetermined location with a remote storage location in response to a synchronization condition.

18. The apparatus of claim 17, wherein the remote storage location comprises a server device.

19. The apparatus of claim 18, further comprising:
means for requesting, at a second client device, access to the server device; and
means for accessing, at the second client device, data items stored in the remote storage location in response to receiving permission from the server device.

20. A computer program product, in a computer readable medium, for remotely storing data, comprising:
instructions for opening a first data item in an application on a first client device;
instructions for storing at least a portion of the first data item in a predetermined storage location on the first client device in response to an action from a user; and
instructions for automatically synchronizing contents of the predetermined location with a remote storage location in response to a synchronization condition.
